(19) United States
(12) Patent Application Publication
(10) Pub. No.: US 2012/0229107 A1
(43) Pub. Date: Sep. 13, 2012

(54) SYSTEM AND METHOD FOR CURRENT SENSING WITHIN A VOLTAGE REGULATOR

(75) Inventors: SICHENG CHEN, Plano, TX (US); CONGZHONG HUANG, Plano, TX (US); SHEA PETRICEK, Dallas, TX (US)

(73) Assignee: INTERSIL AMERICAS INC., Milipitas, CA (US)

(21) Appl. No.: 13/275,761

(22) Filed: Oct. 18, 2011

Related U.S. Application Data
(60) Provisional application No. 61/451,704, filed on Mar. 11, 2011.

(51) Int. Cl. G05F 1/10

(52) U.S. Cl. 323/271

(57) ABSTRACT

A current sense amplifier includes a high-side current sense amplifier and a low-side current sense amplifier. The high-side current sense amplifier provides a current sense voltage signal for use with a voltage regulator and generates the current sense voltage signal responsive to a first current sensed through a high-side switching transistor in a first mode when the high-side switching transistor is turned on and the low-side switching transistor is turned off. The high-side current sense amplifier generates the current sense voltage signal responsive to a second current through the low-side switching transistor in a second mode when the low-side switching transistor is turned on and the high-side switching transistor is turned off. The low-side current sense amplifier senses the second current through the low-side switching transistor and generates a current control signal to the high-side current sense amplifier in the second mode.

### CROSS-REFERENCE TO RELATED APPLICATIONS

This application claims priority of U.S. Provisional Application No. 61/451,704, filed Mar. 11, 2011, entitled CURRENT SENSE AMPLIFIER (Atty. Dkt. No. INTS-30,672), the specification of which is incorporated herein by reference.

### BRIEF DESCRIPTION OF THE DRAWINGS

For a more complete understanding, reference is now made to the following description taken in conjunction with the accompanying Drawings in which:

FIG. 1 is a block diagram of a buck regulator with current sense amplifier;

FIG. 2 illustrates a block diagram of an embodiment of a current sense amplifier for use with a buck regulator;

FIG. 3 illustrates the waveforms associated with the operation of the circuit of FIG. 2; and

FIG. 4 is a block diagram of an electronic/electric system including electronic/electric circuitry/devices including the circuitry described herein.

### DETAILED DESCRIPTION

Referring now to the drawings, wherein like reference numbers are used herein to designate like elements throughout, the various views and embodiments of current sense amplifier are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

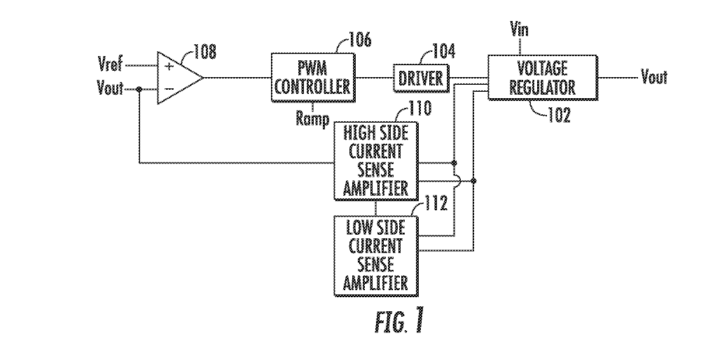

Referring now to the drawings, and more particularly to FIG. 1, there is illustrated a block diagram of a voltage regulator and associated current sensor and control circuitry. The voltage regulator 102 is connected to receive the input voltage V_{IN} and drive control signals from an associated driver circuit 104 to generate a regulated output voltage V_{OUT}. The driver circuit 104 generates the driver signals to the voltage regulator 102 responsive to a PWM control signal from a PWM controller 106. The PWM controller 106 generates the PWM control signal responsive to an error voltage signal from an error amplifier 108 and a provided ramp voltage. The error amplifier 108 generates the error voltage responsive to a provided reference voltage V_{REF} and the output voltage V_{OUT} along with a current sense voltage signal provided by a high side current sense amplifier 110. As will be more fully described hereinbelow, the high side current sense amplifier 110 provides the current sense signal to the error amplifier 108 and detects current across the high side switching transistor within the voltage regulator 102 in a second mode of operation. The low side current sense amplifier 112 detects current across the low side switching transistor of the voltage regulator 102 and provides this information to the high side current sense amplifier 110 for a generation of a current control signal (the current sense voltage signal in a first mode of operation.

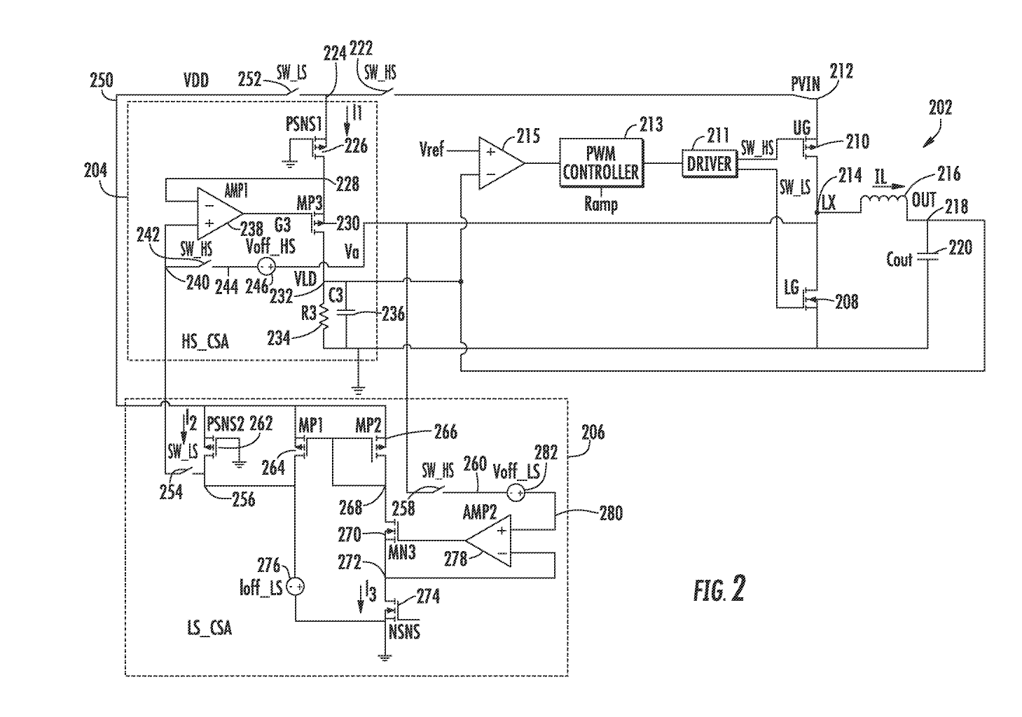

Referring now to FIG. 2, there is illustrated a control scheme for a buck regulator 202 including a high side current sense amplifier 204 and a low side current sense amplifier 206. The scheme uses an additional valley current sensor as the low side current sense amplifier 206 for detecting current on the low side switching transistor 208 to provide inductor current information for both the low side switching transistor 208 and the high side switching transistor 210. The high side switching transistor 210 has its source/drain path connected between the input voltage node 212 and the phase node 214. The low side switching transistor 208 has its source/drain path connected between the phase node 214 and ground. An inductor 216 is connected between node 214 and the output voltage node 218. A load capacitor 220 is connected between the output voltage node 218 and ground.

The high switching transistor 210 is driven by a control signal SW_HS provided from driver circuitry 211. The driver circuitry 211 additionally provides the SW_LS control signal for driving the low side switching transistor 208. The driver circuitry 211 generates the driver control signal responsive to a PWM control signal from a PWM controller 213. The PWM controller 213 generates the PWM control signal responsive to an error voltage signal received from an error amplifier 215 and a ramp voltage signal V_{RAMP}. The error amplifier 215 generates the error voltage responsive to a reference voltage V_{REF} and the output voltage V_{OUT} with the voltage VLD provided from node 232 of the high side current sense amplifier 204 as will be more fully described hereinbelow.

The high side current sense amplifier 204 is connected to the buck regulator 202 at node 212 and node 214. A switch 222 is connected between the input voltage node 212 and node 224. A sense transistor 226 has its source/drain path connected between node 224 and node 228. Switch 222 is turned on and off responsive to a control signal SW_HS. The switch 222 eliminates the effect of the ringing on the PVIN node 212 when high side switching transistor 210 is turned on. When high side switching transistor 210 turns “on”, switch 222 is turned “on” with an appropriate delay responsive to control signal SW_HS. Switch 222 is turned “on” during the “off” time of switch 210 (i.e. during the on-time of switch 208), to prevent the high side current sense circuitry from being de-powered during the low side current sense time (causing the low side current sense circuit to be non-functional). Thus, the switch 222 is “on” during most of the switching cycle aside from a very short time in each switching cycle around the turn-on instant of high side switch 210. The gate of transistor 226 is connected to ground. A transistor 230 has its source/drain path connected between node 228 and node 232. Node 232 comprises the VLD node which provides the output of the high side current sense amplifier 204.

VLD is the measurement of inductor current used in the peak current mode control. A resistor 234 is connected between node 232 and ground. A capacitor 236 is in parallel with resistor 234 between node 232 and ground. An error amplifier 238 has its output connected to the gate of transistor 230. The inverting input of error amplifier 238 is connected to node 228 and the non-inverting input is connected to node 240. A switch 242 is connected between node 240 and node 244. Switch 242 is responsive to a control signal SW_HS. Switch 242 is closed when high side switching transistor 210 is turned on connecting node 240 to node 244. When the high side switching transistor 210 is turned off, switch 242 is open. When node 240 is connected to node 244, the high side offset voltage V_{OFF}_{_{—}}HS source 246 is connected between the phase node 214 and the non-inverting input of error amplifier 238.

The low side current sense amplifier 206 is connected to the buck regulator at the phase node 214 and V_{DD} node 250. The low side current sense amplifier 206 is connected to the buck regulator 202 and high side current sense amplifier 204 through three separate switches. These include switch 252 connecting node 250 with node 224. Switch 252 is responsive to the SW_LS signal and is closed when the low side switching transistor 208 is turned on and opened when the low side switching transistor 208 is turned off. Switch 254 is connected between node 240 of the high side current sense amplifier 204 and node 256 of the low side current sense amplifier 206. Finally, a switch 258 connects node 260 of the low side current sense amplifier 206 to the phase node 214. A transistor 262 has its gate connected to ground and its source/drain path connected between node 250 (V_{DD}) and node 256. A current mirror consisting of transistor 264 and 266 has a drain/source path of transistor 264 connected between node 250 and node 256 and its gate connected to transistor 266. The source/drain path of transistor 266 is connected between node 250 and node 268. A transistor 270 has its source/drain path connected between node 268 and node 272. A transistor 274 has its source/drain path connected between node 272 and ground. The gate of transistor 274 is connected to V_{IN} since it is the sense MOSFET of LG. An offset voltage source I_{OFF}_{_{—}}LS 276 is connected between ground and node 256. The negative terminal of the voltage source 276 is connected to node 256, and the positive terminal is connected to ground.

An error amplifier 278 has the output connected to the gate of transistor 270. Inverting input of error amplifier 278 is connected to node 272 and its non-inverting input is connected to node 280. A voltage source 282 is connected between the non-inverting input of the error amplifier 278 at node 280 and node 260. The positive terminal of voltage source V_{OFF}_{_{—}}LS is connected to node 280 and the negative terminal of voltage source 282 is connected to node 260. When the high side switch 210 is turned on and a low side switch 208 is turned off, the switch 242 and switch 222 are closed, while switch 252, switch 258 and switch 254 are each opened causing the high side current sense amplifier 204 to monitor the high side switch 210 current.

When the high side switch 210 turns off, switches 242 and 222 are opened and instead of pulling VLD to ground, switches 252, 254 and 258 are closed causing the low side current sense amplifier 206 to provide current information in concert with the high side current sense amplifier 204 at node VLD 232. Amplifier 278 within the low side current sense amplifier 206 forces the voltage drop across switching transistor 274 to equal the voltage drop across the lower transistor 208 plus the offset voltage V_{OFF}_{_{—}}LS from the voltage source 282. The current I₂ through transistor 262 equals K(IL×I_{X2}), where Iₓ₂ is determined by V_{OFF}_{_{—}}LS and I_{OFF}_{_{—}}LS. Amplifier 278 will also force I₁=I₂=K(IL×Iₓ₂). By proper trimming, the value of Iₓ₁ can equal Iₓ₂ and the inductor current is continuously mirrored to transistor 226.

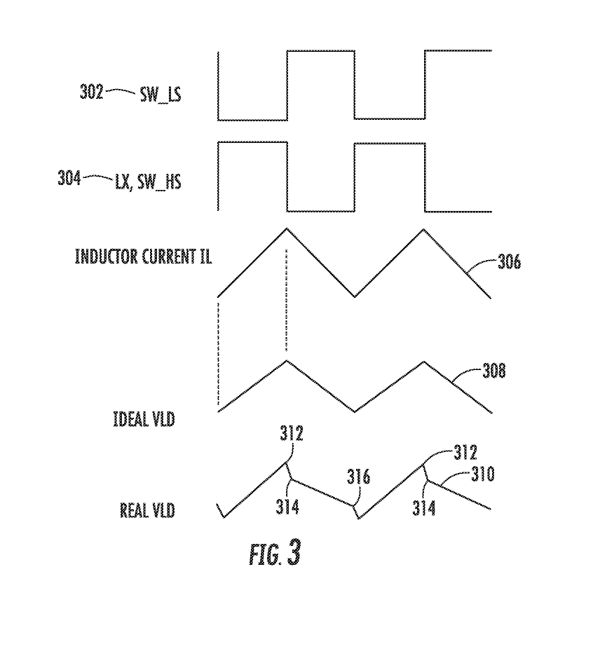

Referring now to FIG. 3, is illustrated the operation of the waveforms with respect to the circuit of FIG. 2. The SW_LS signal 302 indicates when the lower switching transistor and switches controlled by the SW_LS control signal are turned on and off. These switches are turned on responsive to a logical high condition on the SW_LS signal and turned off responsive to a logical low signal. Likewise, the SW_HS signal indicate when the upper switching transistor 210 and the switches controlled by the SW_HS control signal are turned on and off. These switches are turned on responsive to a logical high condition and turned off response to a logical low condition. The inductor current 306 is represented by the waveform shown. Inductor current 306 increases when the upper switching transistor 210 is turned on and the lower switching transistor 208 is turned off. The inductor current 306 decreases when the upper switching transistor 210 is turned off and the lower switching transistor 208 is turned on.

The ideal VLD signal 308 is provided at node 232 of the high side current sense amplifier 304. The high side current sense amplifier output VLD signal 308 increases and decreases in a similar fashion as the inductor current 306. The operation of the real VLD 310 signal is provided from the output of the high side current sense amplifier 304 in the real mode of operation. In the real mode of the operation, the real VLD signal 310 is pulled slightly lower at point 312 when the SW_HS signal goes low and the SW_LS signal goes high turning on the low side switching transistor and off the high side switching transistor.

The real VLD signal 310 will drop slightly from 312 to 314 as the circuit transitions from monitoring the inductor current using the high side current sense amplifier 204 to using the low side current sense amplifier 206. The real VLD signal 310 from point 314 to point 316 is generated responsive to the low side current sense amplifier 206 output that is provided to the high side current sense amplifier 204 such that a more accurate representation of the sensed inductor current is provided. Without the input from the low side current sense amplifier 206, the real VLD signal 310 would drop to zero when the high side switching transistor 210 is turned off and the low side switching transistor 208 is turned on. Thus, providing a more accurate representation of the sensed inductor current is provided via the VLD signal 310.

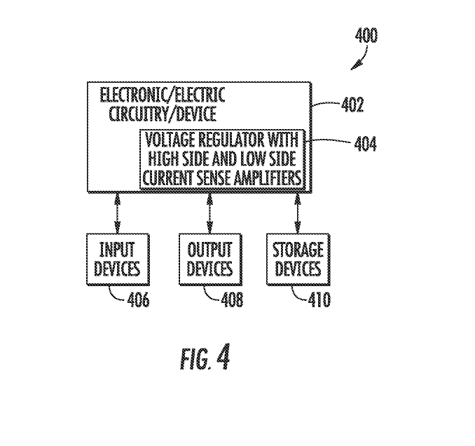

Voltage regulators and associated circuitry according to the embodiments of the present disclosure can be embodied as a variety of different types of electronic devices and systems, such as computers, cellular telephone, personal digital assistants, and industrial systems and devices. More specifically, some applications include, but are not limited to, CPU power regulators, chip regulators, point of load power regulators and memory regulators. FIG. 4 is a block diagram of an electronic/electric system 400 including electronic/electric circuitry/devices 402 including the voltage regulator with high side and low side current sense amplifiers 404 as described with respect to FIGS. 1-3. The electronic/electric circuitry/devices 402 include circuitry for performing various functions required for the given system, such as executing specific software to perform specific calculations or tasks where the electronic system is a computer system. In addition, the electronic/electric system 400 may include one or more input devices 406, such as a keyboard, mouse or touchpad coupled to the electronic circuitry/device 402 to allow an operator to interface with the system. Typically, the electronic/electric system 400 also includes one or more output devices 408 coupled to the electronic/electric circuitry/device 402, such output devices typically including a video display such as a LCD display. One or more data storage devices 410 are also typically coupled to the electronic/electric circuitry/device 402 to store data or retrieve data from storage media. Examples of typical storage devices 410 include magnetic disc drives, tape cassettes, compact discs read only (CD ROMS) and compact discs (CD R/W) memories, and digital video discs (DVDs), flash memory drives, and so on.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An apparatus, comprising:
a voltage regulator for generating a regulated output voltage responsive to an input voltage and drive control signals, the voltage regulator including a high-side switching transistor and a low-side switching transistor;
a driver circuit for generating the drive control signals responsive to a PWM control signal;
a PWM controller for generating the PWM control signal responsive to an error voltage and a ramp voltage;
a error amplifier for generating the error voltage responsive to a reference voltage, the regulated output voltage and a current sense voltage signal;
a low-side current sense amplifier for sensing a first current through the low-side switching transistor and generating a first current sense signal responsive thereto in a first mode of operation when the low-side switching transistor is turned on and the high-side switching transistor is turned off; and
a high-side current sense amplifier for providing the current sense voltage signal responsive to the first current sense signal in the first mode of operation and for sensing a second current through the high-side switching transistor and providing the current sense voltage signal responsive thereto in a second mode of operation when the high-side switching transistor is turned on and the low-side switching transistor is turned off.

2. The apparatus of claim 1, further including a plurality of switches for connecting the high-side current sense amplifier to monitor the second current through the high-side switching transistor in the second mode of operation and for connecting the high-side current sense amplifier and the low-side current sense amplifier to monitor the first current through the low-side switching transistor in the first mode of operation.

3. The apparatus of claim 1, wherein the high-side current sense amplifier further comprises:
a first transistor;
a first error amplifier for forcing a first voltage across the first transistor equal to a second voltage across the high-side switching transistor plus an offset voltage in the second mode of operation; and
a voltage source for generating the offset voltage.

4. The apparatus of claim 3, wherein the first current through the high-side switching transistor is mirrored to the first transistor of the high side current sense amplifier.

5. The apparatus of claim 4 wherein the current sense output is generated responsive to the mirrored current through the first transistor.

6. The apparatus of claim 3, wherein the low-side current sense amplifier further comprises:
a second transistor;
a third transistor;
a second amplifier for forcing a third voltage across the second transistor equal to a fourth voltage across the low-side switching transistor plus a second offset voltage and generates a first current through the third transistor, wherein the second amplifier further mirrors the first current through the third transistor to equal a second current through the first transistor in the first mode of operation.

7. The apparatus of claim 6 wherein the current sense output is generated responsive to the mirrored current through the first transistor.

8. A current sense amplifier, comprising:
a high-side current sense amplifier for providing a current sense voltage signal for use with a voltage regulator, the high-side current sense amplifier generating the current sense voltage signal responsive to a first current sensed through a high-side switching transistor of the voltage regulator in a first mode of operation when the high-side switching transistor is turned on and the low-side switching transistor of the voltage regulator is turned off, the high-side current sense amplifier generating the current sense voltage signal responsive to a second current through the low-side switching transistor in a second mode of operation when the low-side switching transistor is turned on and the high-side switching transistor is turned off;
a low-side current sense amplifier for sensing a the second current through the low-side switching transistor of the voltage regulator and generating a current control signal to the high-side current sense amplifier in the second mode of operation.

9. The current sense amplifier of claim 8, further including a plurality of switches for connecting the high-side current sense amplifier to monitor the first current through the high-side switching transistor in the first mode of operation and for connecting the high-side current sense amplifier and the low-side current sense amplifier to monitor the second current through the low-side switching transistor in the second mode of operation.

10. The current sense amplifier of claim 8, wherein the high-side current sense amplifier further comprises:
a first transistor;
a first error amplifier for forcing a first voltage across the first transistor equal to a second voltage across the high-side switching transistor plus an offset voltage in the first mode of operation; and
a voltage source for generating the offset voltage.

11. The current sense amplifier of claim 10, wherein the first current through the high-side switching transistor is mirrored to the first transistor of the high side current sense amplifier.

12. The current sense amplifier of claim 11 wherein the current sense output is generated responsive to the mirrored current through the first transistor.

13. The current sense amplifier of claim 10, wherein the low-side current sense amplifier further comprises:
a second transistor;
a third transistor;
a second amplifier for forcing a third voltage across the second transistor equal to a fourth voltage across the low-side switching transistor plus a second offset voltage and generates a first current through the third transistor, wherein the second amplifier further mirrors the first current through the third transistor to equal a second current through the first transistor in the second mode of operation.

14. The current sense amplifier of claim 13 wherein the current sense output is generated responsive to the mirrored current through the first transistor.

15. A method for sensing a current in a voltage regulator, comprising:
sensing a first current through a high-side switching transistor of the voltage regulator in a first mode of operation when the high-side switching transistor is turned on and a low-side switching transistor is turned off;
generating a sensed current voltage signal responsive to the first current in the first mode of operation;
sensing a second current through a low-side switching transistor in a second mode of operation when the low-side switching transistor is turned on and the high-side switching transistor is turned off;
generating a current control signal responsive to the sensed second current; and
generating the sensed current voltage signal responsive to the current control signal in the second mode of operation.

16. The method of claim 15, further including:
connecting a high-side current sense amplifier to monitor the first current through the high-side switching transistor in the first mode of operation; and
connecting the high-side current sense amplifier and a low-side current sense amplifier to monitor the second current through the low-side switching transistor in the second mode of operation.

17. The method of claim 15, wherein sensing the first current further comprises forcing a first voltage across a first transistor in the high-side current sense amplifier equal to a second voltage across the high-side switching transistor plus an offset voltage in the first mode of operation.

18. The method of claim 17, further including mirroring the first current through the high-side switching transistor to the first transistor of the high side current sense amplifier.

19. The method of claim 18, wherein generating the current sense output further comprises generating the current sense output responsive to the mirrored current through the first transistor.

20. The method of claim 15, wherein sensing the second current further comprises:
forcing a third voltage across a transistor within the low-side current sense amplifier equal to a voltage across the low-side switching transistor plus a second offset voltage;
generating a first current through a second transistor within the low-side current sense amplifier; and
mirroring the first current through the second transistor within the low-side current sense amplifier to equal a second current through the first transistor within the high-side current sense amplifier in the second mode of operation.

21. The method of claim 20, wherein generating the current sense output further comprises generating the current sense output responsive to the mirrored current through the first transistor within the high-side current sense amplifier.

22. The method of claim 15, further including:
generating an error voltage responsive to the sensed current voltage signal, a reference voltage and a regulated output voltage;
generating a PWM control signal responsive to the error voltage signal and a ramp voltage signal;
generating drive control signals responsive to the PWM control signal; and
providing the regulated output voltage by controlling the high-side switching transistor and the low-side switching transistor responsive to the drive control signals and an input voltage.

23. A system, comprising:
a voltage regulator for generating a regulated output voltage responsive to an input voltage and drive control signals, the voltage regulator including a high-side switching transistor and a low-side switching transistor;
a driver circuit for generating the drive control signals responsive to a PWM control signal;
a PWM controller for generating the PWM control signal responsive to an error voltage and a ramp voltage;
a error amplifier for generating the error voltage responsive to a reference voltage, the regulated output voltage and a current sense voltage signal;
a high-side current sense amplifier for providing the current sense voltage signal, the high-side current sense amplifier generating the current sense voltage signal responsive to a first current sensed through the high-side switching transistor in a first mode of operation when the high-side switching transistor is turned on and the low-side switching transistor of the voltage regulator is turned off, the high-side current sense amplifier generating the current sense voltage signal responsive to a second current through the low-side switching transistor in a second mode of operation when the low-side switching transistor is turned on and the high-side switching transistor is turned off;
a low-side current sense amplifier for sensing the second current through the low-side switching transistor of the voltage regulator and generating a current control signal to the high-side current sense amplifier in the second mode of operation; and
a load coupled to the output of the voltage regulator.

24. The system of claim 23, wherein the load is selected from a group consisting of a processor, a memory, an input device, an output device and a storage device.
